(19) United States
(12) Patent Application Publication
(10) Pub. No.: US 2011/0031702 A1
(43) Pub. Date: Feb. 10, 2011

(54) POLYIMIDE RESIN GASKETS FOR DISS OUTLET VALVES

(76) Inventors: D. Bruce WILSON, Spring City, PA (US); John L. Spranger, Waretown, NJ (US)

Correspondence Address: The BOC Group, Inc., 575 MOUNTAIN AVENUE, MURRAY HILL, NJ, 07974-2082, US

(21) Appl. No.: 12/537,272

(22) Filed: Aug. 7, 2009

(51) Int. Cl. F16L 19/03

(52) U.S. Cl. 277/608

(57) ABSTRACT

Gaskets made of a polyimide resin material for use in DISS valve connections are disclosed. Polyimide resin gaskets are relatively low cost and can be used in all types of operations requiring DISS connections. Polyimide gaskets exhibit negligible creep and can be used for long periods of time without significant deterioration of the leak rate.

### FIELD OF THE INVENTION

The present invention relates to gaskets for use in DISS (Diameter Index Safety System) outlet valves, wherein the gaskets are made from a polyimide resin.

### BACKGROUND OF THE INVENTION

The connections standards committee of the Compressed Gas Association (CGA) assigns standard connections for specific gases and establishes detailed dimensions for the manufacture of such connections. These standards serve the primary purpose of preventing interconnection of non-compatible gases and to provide continuity among manufacturers. In addition, the established connections prevent interconnectivity of the same gas at incompatible pressures.

There are four basic groups of valve outlet connectors: (1) general, industrial compressed gas service; (2) self contained breathing gas (SCBA) service; (3) ultra-high-integrity service; and (4) pin-indexed connectors for medical gas service. In North America, outlet connections are usually designated by a three digit number preceded by the letters CGA. Ultra-high-integrity connections often are preceded by the letters DISS, the acronym for Diameter Index Safety System.

The DISS connections are typically gasketed connections made up of four distinct parts as shown in FIGS. 1 and 2. In particular, FIG. 1 is a cross sectional view of a DISS connection 10, that is disassembled. The connector 10, comprises a valve outlet 20, a nipple 30, a nut 40, and a gasket 50. The nipple 30, has a flat end that serves to compress the gasket 50, against a flat outlet sealing area of the valve outlet 20, when the connection 10, is assembled. The nut 40, fits onto the nipple 30, such that a shoulder of the nipple 30, rests on the pushing surface of the nut 40. The gasket 50, is placed on the flat surface of the nipple 30, inside the nut 40, and then straight threads on the nut 40, engage mating threads of the valve outlet 20, and are tightened to compress the gasket 50, between the two sealing surfaces.

An assembled DISS connection is shown in cross section in FIG. 2, particularly showing the gasket 50, compressed between the valve outlet 20, and the nipple 30. Standard valve connections are designed to provide a “bubble-tight” connection, referring to leak testing the connection with a soap solution or immersion in water, wherein the appearance of bubbles indicates a leak. Standard connections are designed to have leakage rate of 1×10⁻³ to 1×10⁻⁵ of helium/second. The achievable leak rate depends on the surface finishes, mechanical condition and gasket material and consistency if difficult to maintain. This is one reason that DISS connections were developed.

DISS connections have been designed for applications where the requirement for system leak integrity is very high. The DISS connector is similar to the standard gasketed connector; i.e. consisting of a valve outlet, nipple, nut and gasket. However, the sealing contact surfaces of the DISS connector are more sophisticated than those of the standard gasketed connectors. In particular, the sealing surfaces of a DISS connection comprise highly polished toroidal beads. When the nut is screwed onto the valve outlet, it pulls the nipple into the valve outlet and compressed the gasket between the beads. The beads are driven into the gasket creating a crush seal with the gasket.

The gasket material for DISS connections is chosen based on its compatibility with different oxidizers as well as the resistance to swelling from contact with different liquefied gases. Most commonly, the gasket for DISS connectors are composed of polychlorotrifluoroethylene (PCTFE), polytetrafluroethylene (PTFE) or nickel. However, each of these materials has disadvantages in terms of cost, integrity, potential for re-use, compatibility and connection life.

Nickel gaskets are costly and because of the crush seal created by the DISS connection, can be used only once. PCTFE and PTFE gaskets are less expensive and have some potential for re-use, but can not be used where rapid cooling and high pressures occur simultaneously. In addition, PCTFE and PTFE gaskets have a relatively short useful life. The use of PCTFE gaskets in operations requiring rapid cooling simultaneously with high pressure, such as silane transfilling operations, can result in leaks that can ultimately lead to fires or explosions. Further, PCTFE and PTFE gaskets experience “creep” or slow plastic flow under normal temperature and pressure conditions, if used for extended time periods, which results in significant increases of leak rate. For example, when using PCTFE gaskets, leak rates can deteriorate from better than 1×10⁻⁹ cc/sec of He to worse than 1×10⁻⁴ cc/sec of He after a few weeks.

For all of the above reasons, there remains a need in the art for improvements to gaskets for use in DISS valve connections.

### SUMMARY OF THE PRESENT INVENTION

The present invention overcomes the problems and disadvantages noted above by providing a gasket made of a polyimide resin material for use in DISS valve connections. By using polyimide resin, a relatively low cost gasket can be produced that can be used in all types of operations, including rapid cooling, high pressure operations. Further, the polyimide gaskets of the present invention exhibit negligible creep and therefore can be used for long periods of time without significant deterioration of the leak rate.

### BRIEF DESCRIPTION OF THE DRAWINGS

FIG. 1 is a cross sectional view of a disassembled DISS valve connector.

FIG. 2 is cross sectional view of an assembled DISS valve connector.

FIG. 3 is a cross sectional view showing dimensions for a DISS valve connector gasket.

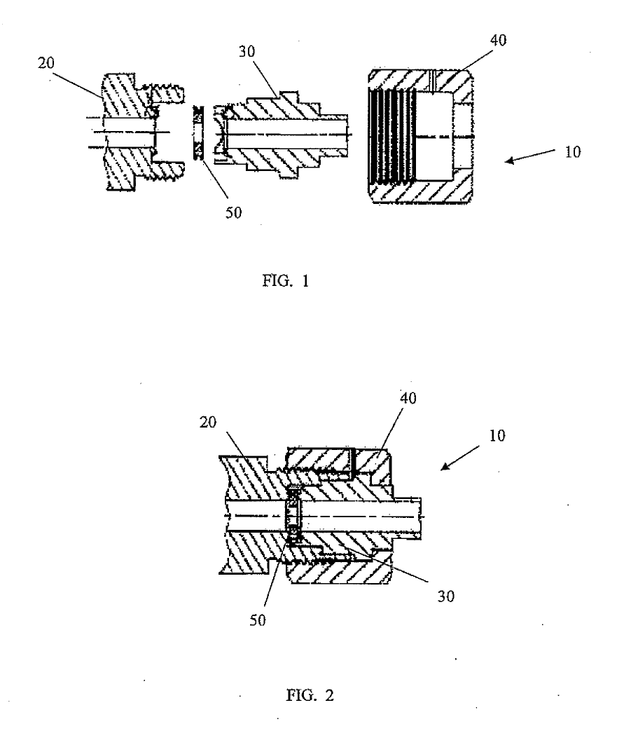

### DETAILED DESCRIPTION OF THE INVENTION

The present invention provides superior DISS valve connections to those none in the prior art. This is accomplished by providing a gasket made of a polyimide resin material. A gasket for DISS connections made of polyimide resin provides several advantages over the gaskets made of nickel, PCTFE, or PTFE known in the prior art.

The polyimide gaskets of the present invention are less expensive than nickel. As noted above because of the crush seal created in a DISS valve connection, a nickel gasket becomes physically deformed and can not be used more than once. Polyimide resin do not permanently deform even in the crush seal of a DISS valve connection and therefore can be used more than once. Further, polyimide resin gaskets do not cause as much wear as nickel gaskets, on other parts of the DISS connection, such as the sealing surfaces of the valve outlet or nipple, and therefore help prolong the useful life of the connector.

Polyimide gaskets also exhibit superior properties to those of PCTFE or PTFE gaskets. Polyimide gaskets exhibit almost no creep (at room temperature) as compared to significant creep by PCTFE or PTFE gaskets. Therefore, polyimide gaskets can be used for longer periods of time without deterioration of the leak rate. In addition, polyimide resin gaskets are less expensive than PCTFE or PTFE gaskets because the polyimide resin gaskets can be reused a greater number of times. Moreover, polyimide gaskets can be used in nearly any type of operation, including those where PCTFE or PTFE gaskets fail.

The polyimide gaskets of the present invention can be made of any suitable polyimide material. One polyimide resin that has been discovered to work well as gaskets in DISS connection according to the present invention is available from Dupont under the product name VESPEL®. In particular, VESPEL polyimide parts are available in five different compositions of SP polyimide resin as more specifically identified in Table 1 below.

TABLE 1
Characteristics of VESPEL Polyimide Material

| Composition | Comments |
|---|---|
| Base Resin | Poly-N,N′-(P,P′-oxydiphenylene)pyromellitimide |
| Material | |
| SP-1 | An unfilled base resin that provides maximum physical |
| | strength, elongation and toughness. Physical and electrical |
| | properties. |
| SP-21 | Includes 15% graphite by weight, for low wear and friction. |
| | Has maximum physical strength, elongation and toughness. |
| | Wear and physical properties. |
| SP-22 | Includes 40% graphite by weight, for enhanced resistance to |
| | wear and friction and improved dimensional and oxidative |
| | stability. Has the lowest coefficient of thermal expansion. |
| | Wear and dimensional stability. |
| SP-211 | Includes 10% TEFLON ® resin and 15% graphite by |
| | weight, for low coefficient of friction over a wide range of |
| | operating conditions and excellent wear resistance up to |
| | 300° F.. Low coefficient of friction and unlubricated wear. |
| SP-3 | Includes 15% molybdenum disulfide by weight, for |
| | maximum wear and friction resistance in vacuum and other |
| | moisture-free environments. Unlubricated sealing and wear |
| | in vacuum and dry environments. |

Gaskets for use in DISS valve connections according to the present invention are particularly useful when made from VESPEL SP-1 polyimide material. Gaskets for DISS connections made from this polyimide material provide superior results compared to the nickel and PTCFE or PTFE gaskets of the prior art. In particular, the gaskets according to the present invention are less expensive and exhibit far less creep at room temperature. The gaskets according to the present invention can be re-used and do not cause excessive wear on other parts of the connection. While particularly useful as DISS valve connection gaskets, the use of polyimide materials for gaskets in VCR applications.

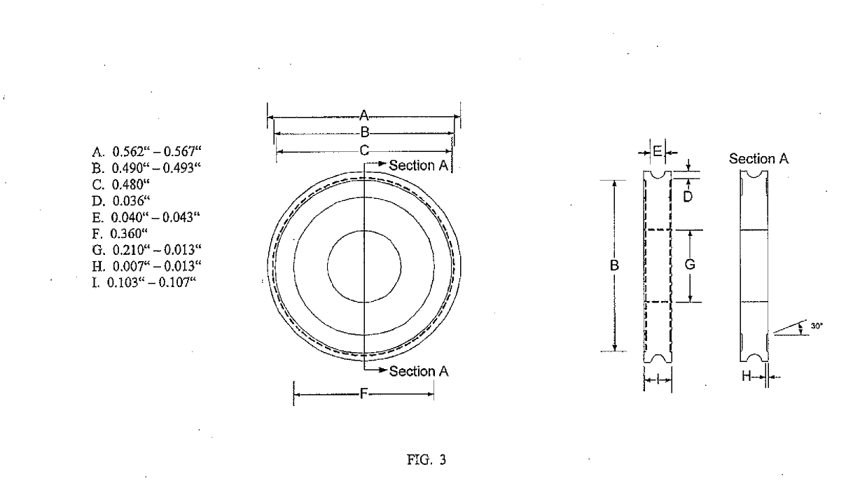

The Compressed Gas Association (CGA) has issued standards for gaskets used in outlet and inlet connections of DISS valves (see DISS Gasket CGA V-A-2005 Standard for Compressed Gas Cylinder Valve Outlet and Inlet Connections). FIG. 3 is a cross sectional view showing the standard dimensions for such a DISS gasket. Gaskets according to the present invention should meet these requirements.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A gasket for a Diameter Index Safety System (DISS) type valve connection made from a polyimide resin material.

2. The gasket according to claim 1, wherein the polyimide resin material is poly-N,N′-(P,P′-oxydiphenylene)pyromellitimide.

3. A Diameter Index Safety System (DISS) valve connection comprising a valve outlet, a nipple, a nut, and a polyimide resin material gasket.

4. The valve connection according to claim 3, wherein the polyimide resin material is poly-N,N′-(P,P′-oxydiphenylene)pyromellitimide.
